(19) United States
(12) Patent Application Publication
(10) Pub. No.: US 2024/0013211 A1
(43) Pub. Date: Jan. 11, 2024

(54) Computer Authentication Using Transaction Questions That Exclude Peer-to-Peer Transactions

(71) Applicant: Capital One Services, LLC, McLean, VA (US)

(72) Inventors: Joshua Edwards, Philadelphia, PA (US); David Septimus, New York, NY (US); Jenny Melendez, Falls Church, VA (US); Tyler Maiman, Melville, NY (US); Samuel Rapowitz, Roswell, GA (US); Viraj Chaudhary, Katy, TX (US)

(21) Appl. No.: 17/857,730

(22) Filed: Jul. 5, 2022

(51) Int. Cl. G06Q 20/40; G06Q 20/22; G06F 40/295; G06F 40/205; G06F 40/166

(52) U.S. Cl. CPC G06Q 20/40; G06Q 20/223; G06F 40/295; G06F 40/205; G06F 40/166

(57) ABSTRACT

Methods, systems, and apparatuses are described herein for improving computer authentication processes through computer-based authentication in a manner that excludes P2P transactions from being presented in false options presented to users. A computing device may receive a request for access to an account from a user. The computing device may provide transaction data to a machine learning model. The computing device may receive one or more merchant names related to P2P transactions from the machine learning model. The computing device may generate a modified set of false merchant choices for the user by excluding merchants related to P2P transactions. An authentication question may be generated, and access to the account may be provided based on a response to the authentication question.

### FIELD OF USE

Aspects of the disclosure relate generally to computer authentication. More specifically, aspects of the disclosure may provide for improvements in the method in which authentication questions are generated by computing devices by processing transaction and merchant information.

### BACKGROUND

As part of determining whether to grant a user access to content (e.g., as part of determining whether to provide a caller access to a telephone system that provides banking information), a user of the user device may be prompted with one or more authentication questions. Such questions may relate to, for example, a password of the user, a personal identification number (PIN) of the user, or the like. Those questions may additionally and/or alternatively be generated based on personal information of the user. For example, when setting up an account, a user may provide a variety of answers to predetermined questions (e.g., “Where was your father born?,” “Who was your best friend in high school?”), and those questions may be presented to the user as part of an authentication process. As another example, a commercially-available database of personal information may be queried to determine personal information for a user (e.g., their birthdate, birth location, etc.), and that information may be used to generate an authentication question (e.g., “Where were you born, and in what year?”). A potential downside of these types of authentication questions is that the correct answers may be obtainable and/or guessable for someone who has information about a particular user.

As part of authenticating a computing device, information about financial transactions conducted by a user of that computing device may be used to generate authentication questions as well. For example, a user may be asked questions about one or more transactions conducted by the user in the past (e.g., “Where did you get coffee yesterday?,” “How much did you spend on coffee yesterday?,” or the like). Such questions may prompt a user to provide a textual answer (e.g., by inputting an answer in a text field), to select one of a plurality of answers (e.g., select a single correct answer from a plurality of candidate answers), or the like. In some instances, the user may be asked about transactions that they did not conduct. For example, a computing device may generate a synthetic transaction (that is, a fake transaction that was never conducted by a user), and ask a user to confirm whether or not they conducted that transaction. Authentication questions can be significantly more useful when they can be based on either real transactions or synthetic transactions: after all, if every question related to a real transaction, a nefarious user could use personal knowledge of a legitimate user to guess the answer, and/or the nefarious user may be able to glean personal information about the legitimate user.

One issue with transaction-based authentication questions is that they might relate to transactions that are not particularly memorable to a user and/or are confusing for a user. This may particularly be the case for payments made related to peer-to-peer (P2P) transactions, where payment was made from a first user to a second use through a third-party service (e.g., the Zelle peer-to-peer payment platform developed by Early Warning Services, LLC at Scottsdale, Arizona or the Venmo peer-to-peer payment platform developed by Venmo, LLC at New York, New York) for shared expense. For example, the first user might consume or use products from merchants that were initially paid by the second user, and the first user might subsequently reimburse the second user using the third-party service via P2P transactions. The payment made to the particular merchants might not be displayed on the first user's transaction records, such that the first user might not be able to easily and/or accurately answer authentication questions based on those P2P transactions. This may particularly be the case for a user that regularly shares expenses with another person through P2P transactions, as certain transactions might not be particularly memorable to the user whether she or another person paid the merchants for a particular product or a service. As such, an authorization process may become frustrating and time-consuming for a user and waste significant amounts of computing resources.

Aspects described herein may address these and other problems, and generally enable a user to be verified in a more reliable and robust manner, thereby improving the safety of financial accounts and computer transaction systems and the user experience during the authentication process.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may allow for improvements in the manner in which authentication questions are used to control access to accounts. The improvements described herein relate to performing computer authentication in a manner that prevents P2P transactions from being presented to a user in an authentication question including one or more false merchant choices. For example, if a user and a friend ordered a meal from a pizzeria using the friend's card, and the user later reimbursed the friend for half of the expense via Zelle payment, the Zelle payment may include a memo line stating “half payment to the pizzeria.” The user might not recall whether she ever had transacted with the pizzeria using her card or her friend paid the pizzeria instead. In such a circumstance, including the name of the pizzeria in the authentication questions and asking the user to identify a false merchant choice based on her own transaction history may confuse the user and frustrate a legitimate user from accessing her account. Conversely, excluding such P2P transactions may increase memorability, promote account accessibility to the users, and better protect their accounts from unauthorized access. As will be described in greater detail below, this process is effectuated by recognizing one or more merchant names in P2P transaction record data (e.g., a memo line) for a particular user using a machine learning model, which may be trained using P2P transaction records related to numerous users. Based on transaction data associated with the particular user, one or more false merchant choices may be determined. A set of modified false merchant choices may be generated for the particular user by excluding certain merchant names reflected in the P2P transaction record data. As such, the modified set of false merchant choices may be presented in an authentication question to minimize confusions and increase account accessibilities in the user community.

More particularly, and as will be described further herein, a computing device may receive a request for access to a first account associated with a first user. For example, the first user may use a first user device to access the first account associated with a financial institution. The computing device may further receive first transaction data from one or more databases, and the first transaction data may describe transactions (e.g., transaction time, transaction amount, and merchant information) conducted by the first user. The computing device may also receive second transaction data corresponding to P2P transactions associated with the first account. The second transaction data may include the metadata or information describing aspects of P2P transactions (e.g., memo line information), such as “split payment for pizzeria,” that is related to the payment in a P2P transaction. The computing device may use training data comprising a history of P2P transaction records associated with a plurality of different users. The computing device may train a first machine learning model to identify entity names in P2P transaction record data. The second transaction data may be provided as input to the trained first machine learning model. The computing device may receive one or more merchant names as output from the trained first machine learning model, and the merchant names may be associated with the P2P transactions conducted by the first account. The computing device may determine false merchant choices (e.g., merchant names that the first user account has not transacted with) in a predetermined period of time (e.g., last month) based on the first transaction data. The computing device may generate a set of modified false merchant choices by excluding the merchant names (e.g., related to P2P transactions) from the false merchant choices. The computing device may generate an authentication question comprising at least one merchant choice from the set of modified false merchant choices. Based on the first transaction data and the set of modified merchant choices, the computing device may generate a correct answer to the authentication question and provide the authentication question to the user device. The computing device may receive a response to the authentication question from the user device. Accordingly, the computing device may grant the user device access to the first account based on comparing the response to the authentication question to the correct answer.

Based on second training data including the history of P2P transaction records of different users, the computing device may train a second machine learning model to determine predicted intent for shared expense for P2P transactions. The second transaction data may be provided as input to the trained second machine learning model. The computing device may receive as output from the trained second machine learning model, and the output may include intent data indicating whether the P2P transactions conducted by the first account are intended for shared expense. The computing device may generate the set of modified false merchant choices based on the intent data.

The second training data may include history of P2P transaction records comprising transaction amounts and transaction frequencies. The computing device may train the second machine learning model based on the transaction amounts and the transaction frequencies, and output whether the P2P transaction have the predicted intent for shared expense.

The first training data may include history of P2P transaction records comprising merchant category information. The computing device may use the trained first machine learning model to determine one or more merchant categories for the P2P transactions conducted by the first account. The computing device may generate the set of modified false merchant choices by excluding merchants matching the determined merchant categories.

The first training data may include history of P2P transaction records comprising capitalization information (e.g., one or more entity names having first letter capitalized) on memo lines. The capitalization information might be useful when there is limited information on the memo line to determine explicit entity names. The computing device may use the trained first machine learning model to determine a potential entity name having its first letter capitalized in the P2P transactions conducted by the first account. The computing device may generate the set of modified false merchant choices by excluding the one or more merchant names starting with such letter.

The computing device may extract metadata or information describing aspects of P2P transactions (e.g., memo line information) by using natural language processing (NLP) to parse the memo line information to extract key words. The computing device may train the first machine learning model to identify the entity names based on the key words.

The P2P transactions may include outbound transactions associated with payments sent by the first account via the P2P transactions. The P2P transactions may include external transactions associated with payments sent by the first account in a first financial institution to an external account in a second financial institution.

Corresponding method, apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure;

FIG. 3 depicts a system comprising different computing devices that may be used in implementing one or more aspects of the disclosure in accordance with one or more illustrative aspects discussed herein;

FIG. 4 depicts a flow chart comprising steps which may be performed for computer-based authentication in a manner that excludes P2P transactions from being presented to users;

FIG. 5 depicts an example interface for a user to provide feedback;

FIG. 6A illustrates illustrative false merchant choices; and

FIG. 6B depicts an example of an authentication question that may be presented to a user.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for improving authentication questions used by a computing device during a computer-implemented authentication process. In particular, the process depicted herein may entail a computer processing data to determine a set of false merchant choices related to a user's transaction history. Certain merchants may be excluded from the false merchant choices to generate a modified set of false merchant choices, because such merchants may appear in P2P transactions that might be potentially confusing to the user. The P2P transactions may be related to outbound transactions for payment made via third-party services (e.g., Zelle or Venmo) for shared expense. In this manner, authentication questions might be generated using the modified set of false merchant choices and presented in a manner which does not undesirably confuse a user. P2P transactions conducted by a user might not be particularly memorable to the user with the respect to the payment method. For example, a first user and a second user may share expense for a dinner at a restaurant, the second user may pay for the dinner with his card, and the first user may later reimburse the second user by transferring fund via Zelle. A transaction record for the fund transfer from the first user to the second user might be generated and stored in a transaction database. As time passes, the first user might recall she had dinner with the second user in the restaurant. The first user might not remember whether she paid for the dinner using her card or via Zelle to the second user. Using the merchant name originated from this P2P transaction in the authentication questions may confuse the legitimate user (e.g., the first user) and cause the legitimate user to fail the authentication. Conversely, excluding the potential confusing merchant may increase accessibility and promote security on the user accounts.

More particularly, some aspects described herein may provide for a computing device that may receive, from a user device, a request for access to a first account associated with a first user. The computing device may receive, from one or more databases, first transaction data corresponding to the first account. The first transaction data may indicate one or more transactions conducted by the first user. The computing device may receive second transaction data corresponding to P2P transactions associated with the first account. The second transaction data may include the metadata or information describing aspects of P2P transactions (e.g., memo line information) associated with each of the one or more P2P transactions. The computing device may train, based on a history of P2P transaction records associated with a plurality of different users, a first machine learning model to identify entity names in P2P transaction record data. The computing device may provide, as input to the trained first machine learning model, the second transaction data. The computing device may receive, as output from the trained first machine learning model, one or more merchant names associated with the one or more P2P transactions conducted by the first account. The computing device may determine, based on the first transaction data, one or more false merchant choices associated with the first account. The computing device may generate a set of modified false merchant choices by excluding the one or more merchant names from the one or more merchant choices. The computing device may generate an authentication question comprising at least one merchant choice from the set of modified false merchant choices. Based on the first transaction data and the set of modified merchant choices, the computing device may generate a correct answer to the authentication question and provide the authentication question to the user device. The computing device may receive, from the user device, a response to the authentication question. Accordingly, the computing device may grant the user device access to the first account based on comparing the response to the authentication question to the correct answer.

The computing device may train a second machine learning model using training data such as a history of P2P transaction records from various users. The second machine learning model may determine predicted intent for shared expense. For example, certain P2P transactions may intend for payment for shared expense. The computing device may use the second transaction data as input to the trained second machine learning model. The computing device may receive, as output from the trained second machine learning model, intent data indicating whether P2P transactions conducted by the first account are intended for shared expense. The computing device may generate the set of modified false merchant choices based on the intent data, such as excluding P2P transactions not intended for shared expense, given that such transactions might be related to payment such as, a tip to the barber (the user and the barber were not sharing any expense), that is unlikely to confuse the specific user.

The training data for the second machine learning model may include transaction amounts and transaction frequencies. Based on the transaction amounts and the transaction frequencies, the second machine learning model may be trained to output the predicted intent for shared expense for the P2P transactions conducted by different users.

The training data for the first machine learning model may include merchant category information. Based on the merchant category information and using the trained first machine learning model, the computing device may determine one or more merchant categories for P2P transactions conducted by the first account. The computing device may generate the set of modified false merchant choices by excluding merchants matching the determined one or more merchant categories.

The training data for the first machine learning model may include entity names having first letter capitalized as indicated on memo lines. The trained first machine learning model may recognize capitalization on the memo line that might be related to entity name in P2P transactions conducted by the first account. The computing device may generate the set of modified false merchant choices by excluding the merchant names starting with certain letters (e.g., all merchant names stating with letter “P”).

The computing device may extract the metadata or information describing aspects of P2P transactions (e.g., memo line information) using natural language processing (NLP) to extract key words. The computing device may train the first machine learning model to identify the entity names based on the key words. The computing device may identify P2P transactions that are outbound transactions. The computing device may identify external P2P transactions that payments were sent by the first account in a first financial institution to an external account in a second financial institution.

Aspects described herein improve the functioning of computers by improving the accuracy and security of computer-implemented authentication processes. The steps described herein recite improvements to computer-implemented authentication processes, and in particular improve the accuracy and utility of authentication questions used to provide access to computing resources. This is a problem specific to computer-implemented authentication processes, and the processes described herein could not be performed in the human mind (and/or, e.g., with pen and paper). For example, as will be described in further detail below, the processes described herein rely on the processing of transaction data, the dynamic computer-implemented generation of authentication questions, and the use of various machine learning models.

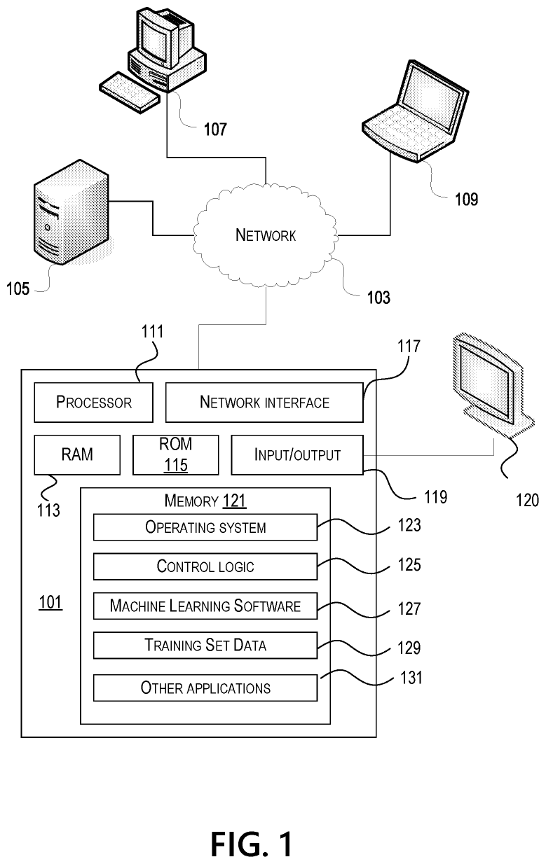

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, and training set data 129. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

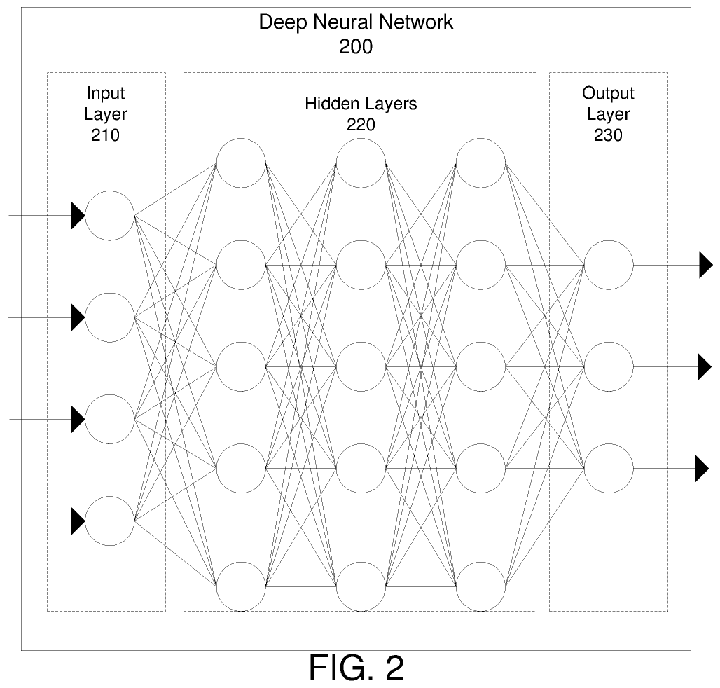

FIG. 2 illustrates an example deep neural network architecture 200. Such a deep neural network architecture might be all or portions of the machine learning software 127 shown in FIG. 1. That said, the architecture depicted in FIG. 2 need not be performed on a single computing device, and might be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

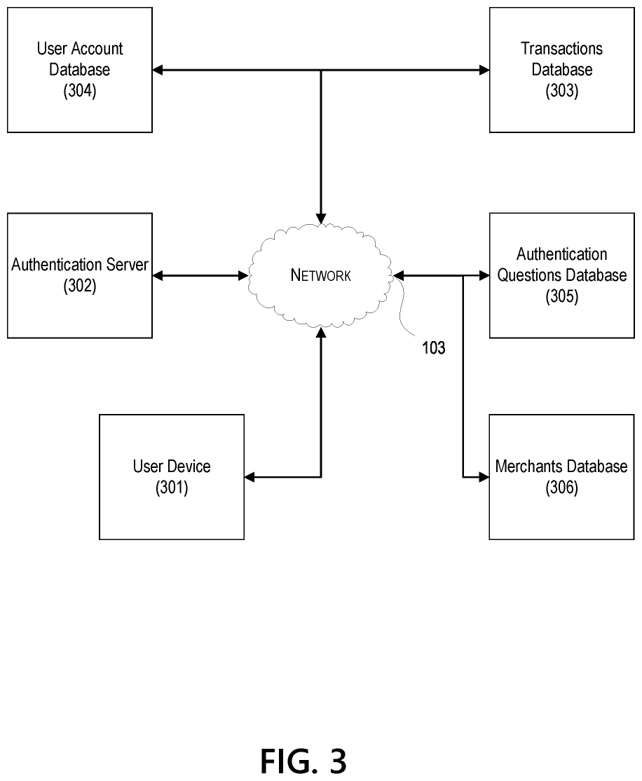

FIG. 3 depicts a system for authenticating a user device 301. The user device 301 is shown as connected, via the network 103, to an authentication server 302, a transactions database 303, a user account database 304, an authentication questions database 305, and a merchants database 306. The network 103 may be the same or similar as the network 103 of FIG. 1. Each of the user device 301, the authentication server 302, the transactions database 303, the user account database 304, the authentication questions database 305, and/or the merchants database 306 may be one or more computing devices, such as a computing device comprising one or more processors and memory storing instructions that, when executed by the one or more processors, perform one or more steps as described further herein. For example, any of those devices might be the same or similar as the computing devices 101, 105, 107, and 109 of FIG. 1.

As part of an authentication process, the user device 301 might communicate, via the network 103, to access the authentication server 302 to request access (e.g., to a user account). The user device 301 shown here might be a smartphone, laptop, or the like, and the nature of the communications between the two might be via the Internet, a phone call, or the like. For example, the user device 301 might access a website associated with the authentication server 302, and the user device 301 might provide (e.g., over the Internet and by filling out an online form) candidate authentication credentials to that website. The authentication server 302 may then determine whether the authentication credentials are valid. For example, the authentication server 302 might compare the candidate authentication credentials received from the user device 301 with authentication credentials stored by the user account database 304. In the case where the communication is telephonic, the user device 301 need not be a computing device, but might be, e.g., a conventional telephone.

The transactions database 303 might comprise data relating to one or more transactions conducted by one or more financial accounts associated with an organization. For example, the transactions database 303 might maintain all or portions of a general ledger for various financial accounts associated with one or more users at a particular financial institution. The data stored by the transactions database 303 may indicate one or more merchants (e.g., where funds were spent), a transaction amount spent (e.g., in one or more currencies), a transaction date and/or time (e.g., when funds were spent), or the like. The data stored by the transactions database 303 might be generated based on one or more transactions conducted by one or more users. For example, a new transaction entry might be stored in the transactions database 303 based on a user purchasing an item at a store online and/or in a physical store. As another example, a new transaction entry might be stored in the transactions database 303 based on a recurring charge (e.g., a subscription fee) being charged to a financial account.

The data stored by the transactions database 303 might be related to a fund transfer between a first user account and a second user account, such as P2P transactions via a third-party service (e.g., Zelle or Venmo). P2P transactions may involve transactions from one user to another user for a product or service provided by a merchant, but need not be in any particular format. For example, the P2P transactions may include outbound transactions related to the first user for payment from the first user account to the second user account for a service rendered by a first merchant. Likewise, the P2P transactions may include inbound transactions related to the first user for payment from the second user account to the first user account for a product procured by a second merchant. The first user and the second user may be customers associated with a same financial institution. The first user may be a customer of a first financial institution, and the second user may be a customer of a second financial institution. The data stored by the transactions database 303 might include a recipient's name, phone number, email address, account number, transaction amount, and alike. If the fund transfer is between users belonging to different financial institutions, the data stored by the transactions database 303 might include the financial institution information of the recipient (e.g., the recipient identification, the recipient financial institution routing number, the recipient account information). The data stored by the transactions database 303 might be related to payment for shared expenses. For example, data stored by the transactions database 303 might include metadata (e.g., memo line information) associated with the P2P transactions, such as “shared expense for Pizzeria” or “half payment for Oceanview.”

The data stored by the transactions database 303 may be generated based on one or more P2P transactions conducted by the first user and such transactions might not be particularly memorable to the first user. For example, the first user and the second user may share expense for a dinner at a restaurant, the second user may pay for the dinner with his card, and the first user may later reimburse the second user by transferring fund via Zelle. A transaction record for the fund transfer from the first user to the second user might be generated and stored in the transaction database 303. As time passes, the first user might recall she had dinner with the second user in the restaurant. The first user might not remember whether she paid for the dinner using her card or via Zelle to the second user. Her transaction record may indicate a fund transfer to the second user via Zelle, not a payment to the merchant. Using the merchant name (e.g., the restaurant name) originated from this P2P transaction in the authentication questions may confuse the legitimate user (e.g., the first user) and cause the legitimate user to fail the authentication.

The user account database 304 may store information about one or more user accounts, such as a username, password, a billing address, an emergency contact, a phone number, other demographic data about a user of the account, or the like. For example, as part of creating an account, a user might provide a username, a password, and/or one or more answers to predetermined authentication questions (e.g., “What is the name of your childhood dog?”), and this information might be stored by the user account database 304. The authentication server 302 might use this data to generate authentication questions. The user account database 304 might store demographic data about a user, such as her age, gender, billing address, occupation, education level, income level, and/or the like.

The account data stored by the user account database 304 and the transactions database 303 may, but need not be related. For example, the account data stored by the user account database 304 might correspond to a user account for a bank website, whereas the financial account data stored by the transactions database 303 might be for a variety of financial accounts (e.g., credit cards, checking accounts, savings accounts) managed by the bank. As such, a single user account might provide access to one or more different financial accounts, and the accounts need not be the same. For example, a user account might be identified by a username and/or password combination, whereas a financial account might be identified using a unique number or series of characters.

The authentication questions database 305 may comprise data which enables the authentication server 302 to present authentication questions. An authentication question may be any question presented to one or more users to determine whether the user is authorized to access an account. For example, the question might be related to personal information about the user (e.g., as reflected by data stored in the user account database 304), might be related to past transactions of the user (e.g., as reflected by data stored by the transactions database 303), or the like. The authentication questions database 305 might comprise data for one or more templates which may be used to generate an authentication question based on transaction information (e.g., from the user account database 304 and/or the transactions database 303). The authentication questions database 305 might additionally and/or alternatively comprise one or more static authentication questions, such as an authentication question that is used for a wide variety of users (e.g., “What is your account number?”). An authentication question might correspond to a transaction occurred or not occurred in the past. The authentication questions database 305 might additionally and/or alternatively comprise historical authentication questions. For example, the authentication questions database 305 might comprise code that, when executed, randomly generates an authentication question, then stores that randomly-generated authentication question for use with other users.

The authentication questions stored in the authentication questions database 305 may be associated with varying levels of difficulty. Straightforward questions that should be easily answered by a user (e.g., “What is your mother's maiden name?”) might be considered easy questions, whereas complicated answers that require a user to remember past transactions (e.g., “How much did you spend on coffee yesterday?”) might be considered difficult questions. The authentication questions stored in the authentication questions database 305 may be associated with varying levels of memorability and guessability. Including one or more false merchant choices in the authentication questions may promote memorability, given that a legitimate user may readily identify a merchant if she does not shop at that merchant in a predetermined period of time. Excluding certain merchants corresponding to P2P transaction conducted by the users may minimize confusion and increase the security of the user accounts.

The merchants database 306 might store data relating to one or more merchants, including the true or false merchant choices for the users. The merchants database 306 may be a merchant database that stores enterprise merchant intelligence records, which may in turn include a merchant identifier, a friendly merchant name, a zip code, a physical address, a phone number, an email or other contact information of the merchants, or a merchant category code (MCC). An MCC may be a four-digit number listed in ISO 18245 for retail financial services and used to classify a business by the types of goods or services it provides. MCCs may be assigned either by merchant type (e.g., one for hotels, one for office supply stores, etc.) or by merchant name. For example, grocery stores are classified as MCC 5411, “Grocery Stores, Supermarket,” convenient stores are classified as MCC No. 5499, “MISC Food Stores—Default.” The merchant records may be collected from public resources or merchant reported records.

A financial organization may build a proprietary version of the merchants database 306, for example, based on an aggregation of transaction records in transactions database 303. As a transaction arrives from a transaction stream, the corresponding transaction record may be processed, cleaned, and/or enhanced with a variety of services. For example, when a financial institution receives the transaction information in a transaction stream, the transaction information may be in the form of a line of data that offers limited information about the transaction, with each piece of information appearing in certain locations within the line of data. The merchant identifier may appear in a specific location and may include 8-10 characters in the abbreviated form, which might not be readily recognizable as a meaningful merchant name, particularly for small business merchants. The financial institution may process this abbreviated merchant identifier and convert it into a meaningful merchant name in a human readable format, and store it in the merchants database 306.

A financial organization may use a third-party API to gather merchant information, such as a merchant address or contact information, to be stored in the merchants database 306. A financial organization may maintain more static merchant information, such as a merchant identifier and MCC, in its proprietary the merchants database 306. A financial institution may use the third-party API to get merchant address, merchant social media handle, or other merchant information that may change over time.

The data stored by the merchants database 306 might be used to generate authentication questions that comprise both correct answers (e.g., based on data from the transactions database 303 indicating one or more real merchants with which a user has conducted a transaction) and false answers (e.g., based on data from the merchants database 306, which might be randomly-selected merchants where a user has not or rarely conducted a transaction). For example, a computing device may receive from merchants database 306 indications (e.g., merchant names, merchant identifiers) of different merchants. The computing device may further receive transaction data from transaction database 303 indicating one or more transactions conducted by a user. The computing device may determine one or more merchants related to a user and store a list of true merchant choices or false merchant choices in the merchants databases 306. The list of the false merchant choices may be further modified by excluding certain merchants corresponding to P2P transactions. For example, the P2P transactions might be conducted by the user that intended to share expense. As such, an authentication question may be generated based on the modified false merchant choices.

Having discussed several examples of computing devices which may be used to implement some aspects as discussed further below, discussion will now turn to a method for computer-based authentication in a manner that excludes P2P transactions from being presented in false options presented to users.

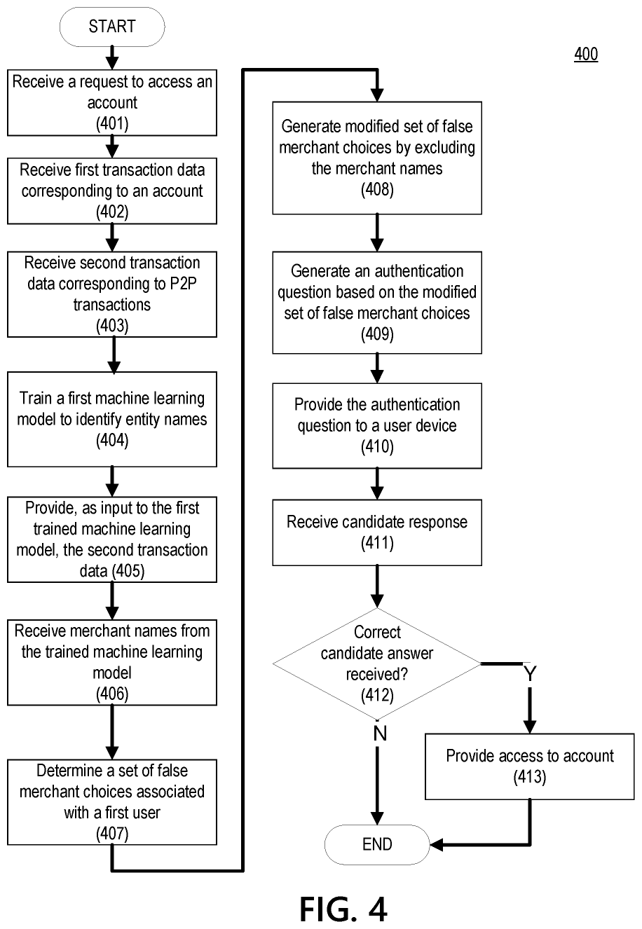

FIG. 4 illustrates an example method 400 for computer-based authentication that excludes P2P transactions from being presented to users in accordance with one or more aspects described herein. The method 400 may be implemented by a suitable computing system, as described further herein. For example, the method 400 may be implemented by any suitable computing environment by a computing device and/or combination of computing devices, such as one or more of the computing devices 101, 105, 107, and 109 of FIG. 1, and/or any computing device comprising one or more processors and memory storing instructions that, when executed by the one or more processors, cause the performance of one or more of the steps of FIG. 4. The method 400 may be implemented in suitable program instructions, such as in machine learning software 127, and may operate on a suitable training set, such as training set data 129. The method 400 may be implemented by computer-readable media that stores instructions that, when executed, cause performance of all or portions of the method 400. The steps shown in the method 400 are illustrative, and may be re-arranged or otherwise modified as desired.

In step 401, a computing device (e.g., authentication server 302) may receive, from a user device, a request for access to an account associated with a first user. The request may be associated with access, by a user, to a website, an application, or the like. The request may additionally and/or alternatively be associated with, for example, a user device calling into an Interactive Voice Response (IVR) system or similar telephone response system. For example, the computing device may receive an indication of a request for access to an account responsive to a user accessing a log-in page, calling a specific telephone number, or the like. The request may specifically identify an account via, for example, an account number, a username, or the like. For example, a user might call an IVR system and be identified (e.g., using caller ID) by their telephone number, which might be used to query the user account database 304 for a corresponding account.

In step 402, the computing device may receive, from one or more databases, first transaction data corresponding to an account of the user. The first transaction data may indicate one or more transactions conducted by the user. The first transaction data may be received from, e.g., the transactions database 303. For example, the first transactions data may comprise transaction data related to purchases of goods and/or services made by the user. The first transactions data might correspond to a period of time, such as a recent period of time (e.g., the last day, the last week, last month, the last two months, or the like). The first transaction data may also indicate whether the user conducted one or more transactions with a particular merchant. The first transaction data might include information related to P2P transactions. For example, a credit card transaction might indicate a Venmo transaction. The computing device might (as part of step 403) use that credit card transaction data to request, from Venmo servers and using the appropriate authentication credentials, information about the P2P transaction itself.

The first transaction data may indicate account profile information. The account profile information may be received from, e.g., the user account database 304. For example, the account data may comprise account profile information related to, such as a billing address, a phone number or an email address. The account data may also indicate demographic data about the user such as age, gender, location, occupation, education level, income level, etc.

In step 403, the computing device may receive second transaction data corresponding to one or more P2P transactions associated with the first account. The second transaction data may also be received from the one or more databases. The P2P transactions may be related to a fund transfer between a first user account and a second user account via a third-party service (e.g., Zelle or Venmo). For example, from the perspective of the first user, the second transaction data may be related to outbound P2P transactions for payment from the first user account to the second user account. Likewise, from the perspective of the first user, the second transaction data may be related to inbound P2P transactions for payment from the second user account to the first user account. The first user and the second user may be customers associated with a same financial institution. The first user and the second user may be customers associated with different financial institutions. For example, the first user may be a customer of a first financial institution, and the second user may be a customer of a second financial institution. The inbound transaction may be associated with a payment for the product or service procured by a first merchant. From the perspective of the first user, the first merchant associated with the inbound P2P transaction might be already recorded in the transaction history of the first user (e.g., the first user using a card to pay the first merchant). As such, the first user may be likely to identify the first merchant as a true merchant given that she made a payment directly to the first merchant. In contrast, the transaction record of the first user might not record a second merchant associated with the outbound P2P transaction (e.g., she sent the payment to the second user via Zelle for shared expense). The first user might not readily identify the second merchant as a false merchant, given that she may not recall that the second user paid the second merchant directly. Indeed, the fact that she consumed the product from the second merchant might confuse her further and mislead her to identify the second merchant as a true merchant. Accordingly, it might be helpful to remove the second merchant associated with the outbound P2P transaction from the false merchant choices to reduce confusion.

The second transaction data may include metadata or information describing aspects of P2P transactions (e.g., memo line information). For example, the memo line information may include a phrase or sentence, such as “shared expense for Pizzeria” or “half payment for Oceanview.” The user may add this memo line information in the P2P transaction to explain the intended purpose for the payment. The second transaction data may include P2P transaction information such as a transaction amount and a transaction frequency between two users.

In step 404, the computing device may train, based on first training data comprising a history of P2P transaction records, a first machine learning model to identify entity names in P2P transaction record data. For example, the first machine learning model may be implemented via the deep neural network 200 and/or the machine learning software 127. The machine learning model may be trained using the first training data including a history of P2P transaction records by a plurality of different users who have conducted P2P transactions in the past. The first training data may be tagged to indicate where, in the P2P transactions, merchant names exist. The plurality of different users may be customers of a financial institution. The history of P2P transaction records may include outbound transactions for fund transfer from one of the plurality of different users to another user in the same financial institution. The P2P transaction records may include outbound transactions for fund transfer from one of the plurality of different users to another user in a different financial institution. Given that the inbound P2P transactions are less likely to cause confusions in the authentication process, the computing device may use outbound P2P transaction records to train the first machine learning model.

The history of P2P transaction records may include metadata or information describing aspects of P2P transactions (e.g., memo line information). The computing device may pre-process the memo line information before feeding it into the first machine learning model. For example, the computing device may use natural language processing (NLP) to parse the memo line information to extract key words. The computing device may remove certain stop words that do not add much meaning to the sentences, such as at, the, is, which, or the like. For example, the computing device may process the memo line information to extract keyword such as “shared expense,” “half payment,” “split payment,” “Pizzeria” or “Oceanview.” The training data may also include pre-tagged entity names associated with the P2P transactions. To train the first machine learning model in this manner, the first machine learning model may be provided with the extracted key words and pre-tagged entity names (e.g., merchant names) from P2P transactions (e.g., outbound P2P transactions) conducted by the plurality of different users. For example, the first machine learning model may be trained to recognize the key words in the memo line information such as “Pizzeria” or “Oceanview” corresponding to entity names.

In some examples, the first machine learning model may be trained to identify entity names using fuzzy search algorithm. For example, the computing device may process the metadata or information describing aspects of P2P transactions (e.g., memo line information) to extract keyword such as “shared expense,” “half payment,” “Pizzeria” or “Oceanview.” The computing device may use a fuzzy search or match algorithm to translate certain key words into entity names. The computing device may take a key word that might look like a merchant name, and do a fuzzy search or match by removing the capitalization, or removing “'s” at the end of the word Pizzeria's. If a word is mis-spelled, the computing device may account for the mis-spellings and recognize the name “Pizzeria,” even it is spelled as “Pizeria.” The computing device may search the key words in the merchant database 306 using this fuzzy search algorithm. If a match is found between a key word and a merchant name in the merchant database 306, the computing device may identify the key words as an entity name. However, in many cases where the memo line may contain limited information, numerous mis-spelling errors, or may lack a strong indication for possible entity names, the first machine learning model may be trained to identify the entity names based on a combination of key words. For example, the entity names may not be a single word (e.g., “On The Hill”). The first machine learning model may be trained to identify not only the individual word, but the distance between two words or different combinations of words to certain extend. For example, the first learning model might not combine a large number (e.g., 10) words to consider whether it is an entity name. But the first machine learning model might combine a relatively smaller number (e.g., up to 6) words to consider whether it is an entity name. For example, the first machine learning model may be trained to identify the combination of words “On The Hill” corresponding to an entity name (e.g., a Mexican restaurant).

The first machine learning model may be trained to identify entity names based on capitalization of certain words on the memo line. For example, the key words on the memo line may include a capitalization of letter “P” and the letters following the letter “P” might not be recognizable. The first machine learning model may identify all merchant names in the merchant database 306 that start with letter “P” and identify these merchant names as candidates to be removed from the potential false merchant choices.

The first machine learning model may be trained to identify entity names based on certain words on the memo line indicating a type of product or service. For example, the memo line may include the key word “coffee.” The first machine learning model may be trained to identify merchant names in the merchant database 306 that belong to the merchant categories (e.g., the MCC) of “coffee shop,” “bakery” or “restaurant.” The computing device may identify various coffee shops, bakeries or restaurants as candidates to be removed from the potential false merchant choices.

The first machine learning model may be additionally and/or alternatively trained to identify the entity names based on other information in the P2P transaction records such as a transaction amount. For example, if the transaction amount for a P2P transaction is 1000, it might be unlikely that the payment is related to an entity name “Pizzeria.” If the transaction amount for a P2P transaction is $30, it might be more likely that the payment matches with the key word “Pizzeria” on the memo line. The first learning model may be trained using the training data that indicates the combination of the key words, the capitalization, the MCC and the transaction amount. The first machine learning model may be trained to assign appropriate weights to these training data.

In some examples, the computing device may train a second machine learning model to determine predicted intent for shared expense based on second training data comprising a history of P2P transaction records from the plurality of different users. The first and second training data may be both related to the same or a similar history, but that the second training data might be tagged to identify something different (e.g., tagged to indicate whether a particular historical transaction was or was not intended to be shared). The P2P transactions in the second training data may include transactions intended for shared expense which may be more likely to cause confusions in the authentication process. For example, if two users share the cost of a purchase of a product from a first merchant, and the first user later transferred funds to the second user via the P2P transaction for half of the payment, including the first merchant as a candidate for the false merchant choices may cause confusion to the first user. Conversely, the P2P transactions may include transactions not intended for shared expense that might be unlikely to cause confusions. For example, if the first user transferred funds to the second user via the P2P transaction as a gift with a suggestion for the second user to purchase a birthday present from a second merchant, including the second merchant in the false merchant choices might not cause confusion to the first user.

The second training data for the second machine learning model may include the history of P2P transaction (e.g., outbound P2P transaction) records and pre-tagged transactions from the plurality of different users that were intended for shared expense. For example, the second machine learning model may be trained to recognize certain key words on the memo line, such as “shared,” “split” or “half payment” that may indicate shared expense. The second training data for the second machine learning model may include user spending patterns, such as a number of purchases made by a particular user in the P2P transactions, a number of merchants associated with the particular user, and one or more types of merchants (e.g., the MCC) that the particular user transacted with. The second machine learning model may be trained based on the transaction amount and transaction frequency to recognize recurrent payment information between a pair of users. If a first user regularly sends payment to a second user, this may indicate that the users frequently interact with each other and share expenses. The second machine learning model may set a threshold that if the first user sends payment to the second user for a threshold number of times or a threshold amount within a predetermined period of time (e.g., monthly), the intent for shared expense may be established. The situation may be, for example, a co-inhabitation situation that the two roommates regularly share expenses for a meal, a utility bill, a cable service, etc.

The second machine model may be different from the first machine learning model. For example, the first machine learning model may be a supervised model and the second machine learning model may be an unsupervised model, and vice versa. The first machine learning model may generate entity names indicating merchant names and the second machine model may determine whether the P2P transactions related to these entity names are intended for shared expense. The merchant names and intent data may be used in subsequent steps to determine candidate merchant choices in the authentication process.

In step 405, the computing device may provide, as input to the trained first machine learning model, second transaction data associated with the first user or first user account. The second transaction data may include one or more P2P transactions conducted by the first user in a predetermined period of time. The second transaction data may include a number of fund transfers for payment made by the first user to other users in the predetermined period of time (e.g., in the past month). For example, the user may conduct six P2P transactions in the last month. The second transaction data may contain metadata or information describing aspects of P2P transactions (e.g., memo line information) including key words related to the outbound P2P transactions. The second transaction data may include additional information such as transaction amounts or transaction frequencies associated the P2P transactions conducted by the first user.

In step 406, the computing device may receive, from the trained first machine learning model, one or more merchant names associated with the one or more P2P transactions conducted by the first user. The trained first machine learning model may output, for example, a confidence value between 0 to 1 to indicate whether a word or a combination of words on the memo line corresponds to one or more merchant names. For example, a confidence value “0” may indicate the word is not a merchant name, while a confidence value “1” may indicate the word corresponds to a merchant name.

The first machine learning model may be re-trained based on user feedback information. Based on the user feedback on whether an entity name is indeed a merchant name, the first machine learning model may adjust the confidence threshold to determine whether the entity name corresponds to a merchant name. For example, the first machine learning model may set a first confidence threshold (e.g., 0.6). The P2P transaction record may identify four entity names from the memo line with the corresponding confidence scores N1=0.9, N2=0.8, N3=0.7 and N4=0.65. Based on the first confidence threshold (e.g., 0.6), the first machine learning model may identify all four entity names N1-N4 corresponding to merchant names. The first machine learning model may adjust the first confidence threshold based on user feedback. For example, the computing device may present entity names N1-N4 to the user and ask the user to identify whether any of the names represent merchant names. If the user reports that N4 is not a merchant name, the first machine learning model may be re-trained to increase the first confidence threshold, for example, from 0.6 to 0.7, so that only N1-N3 would be identified as merchant names.

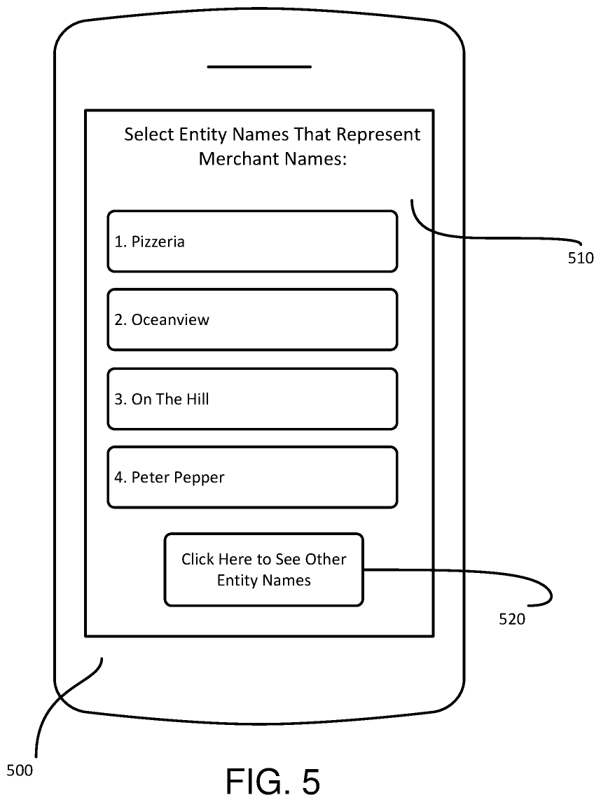

FIG. 5 depicts example interfaces for a user to provide feedback in accordance with the process described above. As illustrated in FIG. 5, the computing device may present to a user an interface 510 on a user device 500 with a list of entity names as indicated in the metadata or information describing aspects of P2P transactions (e.g., memo line information) of the user's P2P transaction record. The computing device may present the list of entity names related to the P2P transactions based on their corresponding confidence scores. For example, the computing device may select the first four names with the highest confidence scores to be presented to the user. The computing device may select names that beyond a first confidence threshold (e.g., 0.6).

In the example of FIG. 5, the computing device may present a list of merchants based on outbound P2P transactions conduct by a user in the past month. The user may select one or more merchants from a list comprising, for example, Pizzeria, Oceanview, On the Hill and Peter Pepper. The computing device may use the corresponding confidence scores Pizzeria (0.9), Oceanview (0.8), On Hill and Peter Pepper (0.65) as part of the tagged training data. The computing device may receive a response from the user for a selection of one or more names that the user does not recognize as a merchant name (e.g., Peter Pepper). The computing device may provide an option 520 for the user to view additional entity names related to P2P transactions in the past month or past six months and provide feedback. The computing device may provide the user feedback as tagged training data to re-train the first machine learning model. The first machine learning model may be re-trained to output a confidence threshold (e.g., 0.7).

In some examples, there is limited information on the memo line associated with the P2P transactions conducted by the user. The trained first machine learning model may generate other output, such as a capitalization (e.g., letter “P”) in the merchant names or a merchant category (e.g., coffee shops) which may be used in subsequent steps to remove certain merchants from the false merchant choices.

In some examples, the computing device may use the trained second machine learning model to determine whether the related P2P transactions are related to shared expense. The computing device may provide, as input to the trained second machine learning model, the second transaction data including the metadata or information describing aspects of P2P transactions (e.g., memo line information). The computing device may receive, as output from the trained second machine learning model, intent data indicating whether the one or more P2P transactions conducted by the first user are intended for shared expense. The merchant names generated by the first machine learning model may be further processed by the trained second machine learning model to eliminate names related to P2P transactions not intended for shared expense. In other examples, the computing device may first use the trained second machine learning model to eliminate P2P transactions that are not intended for shared expense. The computing device may then use the trained first machine learning model to determine merchant names based on P2P transaction records related to transactions intended for shared expense.

In step 407, the computing device may determine a set of false merchant choices associated with the first user or first user account. False merchant choices may comprise one or more merchants, selectable by a user in a user interface, that are not indicated in the transaction data (e.g., a merchant that the user has not transacted with in the past). If a user is asked to answer a question whether she transacted with a merchant in the past, a legitimate user would recognize the false merchant, and respond with an answer “No.” The false merchant choices may be generated based on the first transaction data of the first user in a predetermined period of time. The false merchant choices may include merchants that the first user has not transacted with during the predetermined period of time. For example, the first transaction data may indicate that the user has not transacted with Pizzeria, Oceanview Seafood, MexTex, Pat's Store and ABC Market in the past month.

In step 408, the computing device may generate a modified set of false merchant choices associate with the first user by excluding one or more merchants. The computing device may retrieve a first set of merchant names identified by the first machine learning model. These merchant names may be related to outbound P2P transactions conducted by the first user. The first set of merchant names may be further processed to generate a second set of merchant names by the second machine learning model to remove names that are related to P2P transactions not intended for shared expense. For example, the second set of merchant names may include Pizzeria and Oceanview that are related to P2P transactions intended for shared expense. The computing device may exclude one or more merchants in the second set of merchant names to generate a modified set of merchant choices. For example, the transaction records may indicate that the user has not transacted with Pizzeria, Oceanview Seafood, MexTex, Pat's Store and ABC Market in the past month. The computing device may remove Pizzeria and Oceanview Seafood from the set of false merchant choices. The modified set of merchant choices for the first user now include MexTex, Pat's Store and ABC Market.

The computing device may retrieve one or more capitalization (e.g., letter “P”) identified by the first machine learning model from the metadata or information describing aspects of P2P transactions (e.g., memo line information). The computing device may exclude one or more merchants whose names stating with the letter “P” to generate a modified set of merchant choices. For example, the transaction records may indicate that the user has not transacted with Pizzeria, Oceanview Seafood, MexTex, Pat's Store and ABC Market in the past month. The computing device may remove Pizzeria and Pat's Store from the set of false merchant choices given their names start with letter “P.” The modified set of merchant choices for the first user now include Oceanview Seafood, MexTex and ABC Market.

The computing device may retrieve one or more merchant categories (e.g., coffee shops) identified by the first machine learning model from the metadata or information describing aspects of P2P transactions (e.g., memo line information). For example, the first machine learning model identifies that “coffee” was indicated on the memo line. The user may have had coffee with a friend in a coffee shop, and the user may later reimburse the friend for her share of the cost for the coffee. Due to the limited information from the memo line, the name of the coffee shop might not be readily identified. In this situation, the computing device may remove any merchant related to coffee shops, bakeries or restaurants that may serve coffee. The computing device may retrieve merchants from the merchant database that belong to the “coffee shops/bakery/restaurant” merchant categories. The computing device may exclude these merchants falling within the “coffee shops/bakery/restaurant” merchant categories to generate a modified set of merchant choices. For example, the transaction records may indicate that the user has not transacted with Pizzeria, Oceanview Seafood, MexTex, Pat's Store and ABC Market in the past month. Based on the limited memo information “coffee” identified by the first machine learning model, the computing device may remove Pizzeria, Oceanview Seafood and MexTex falling within the “coffee shops/bakery/restaurant” merchant categories, from the set of false merchant choices. The modified set of merchant choices for the first user now include Pat's Store and ABC Market.

In step 409, the computing device may generate, based on the modified false merchant choices, an authentication question for the first user. The authentication question may include true merchants that the first user has transacted with in a predetermined period of time (e.g., last month). The authentication question may include false merchants that the first user has not transacted with in a predetermined period of time (e.g., last month). The authentication question may ask the first user, for example, whether she has made a purchase at one or more merchants from a list of candidate merchants in the last month. The candidate merchants may include, for example, three merchants from a list of true merchants, and one merchant from a list of false merchants in the set of modified false merchant choices. The authentication question may ask a user, for example, to select one or more merchants from a list of candidate merchants that the user has not made a purchase at one or more merchants in the last month. The candidate merchants may include, for example, three merchants from the list of false merchants in the set of modified merchant choices, and one true merchant from the list of true merchants. The candidate merchants may not include any merchant that has been excluded from the modified set of merchants (e.g., merchants related to outbound P2P transactions intended for shared expense). Using these candidate merchants related to P2P transactions may reduce the likelihood of confusion and promote account security.

In step 410, the computing device may present the authentication question. Presenting the authentication question may comprise causing one or more computing devices to display and/or otherwise output the authentication question. For example, the computing device may cause presentation, to the user, of the authentication question. Such presentation might comprise providing the authentication question in a text format (e.g., in text on a website), in an audio format (e.g., over a telephone call), or the like.

In step 411, the computing device may receive a candidate response to the authentication question. A candidate response may be any indication of a response, by a user, to the authentication question presented in step 410. For example, where an authentication question comprises a candidate merchant, the candidate response might comprise a selection of true or false for the candidate merchant. As another example, in the case of a telephone call, the candidate response might comprise an oral response to an authentication question provided using a text-to-speech system over the call.

In step 412, the computing device may determine whether the candidate answer received in step 411 is correct. Determining whether the candidate answer is correct may comprise comparing the answer to the correct answer determined as part of generating the authentication question in step 409. If the candidate answer is correct, the method 400 proceeds to step 413. Otherwise, the method 400 ends.

In step 413, the computing device may provide access to the account. For example, the computing device may provide, based on the candidate response, the user device access to the account. Access to the account might be provided by, e.g., providing a user device access to a protected portion of a website, transmitting confidential data to a user device, allowing a user to request, modify, and/or receive personal data (e.g., from the user account database 304 and/or the transactions database 303), or the like. In some examples, the computing device may provide the user access to the account when the candidate response is, for example, 100% accurate. Alternatively, or additionally, the computing device may provide the user access to the account based on the user has answered a threshold number of questions correctly (e.g., above 90%).

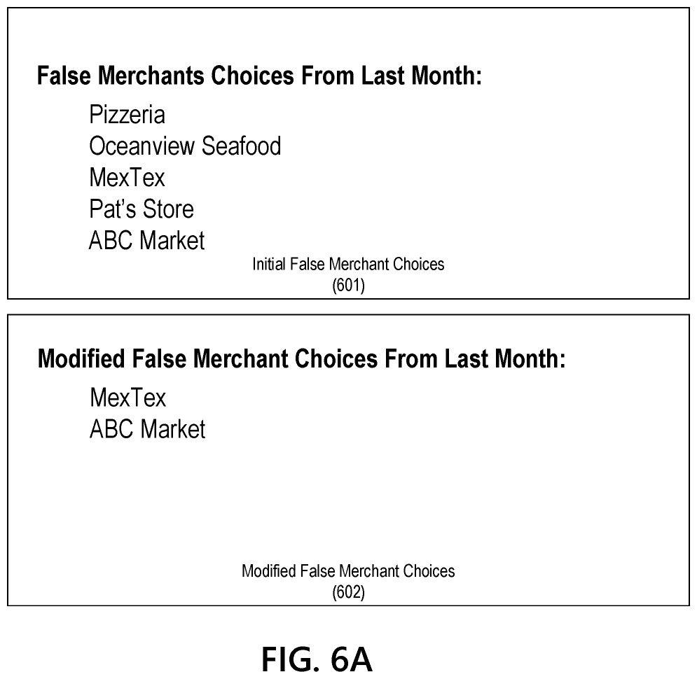

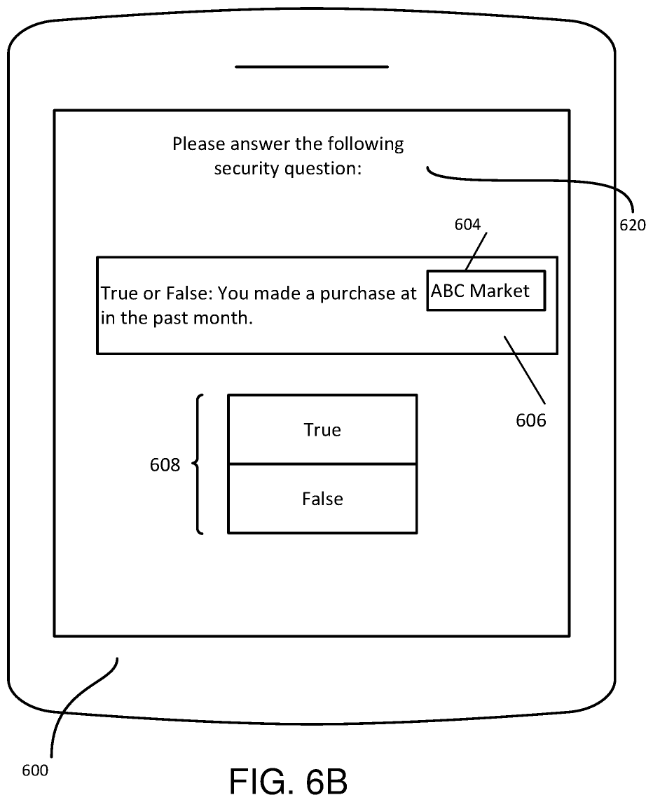

FIGS. 6A-B illustrate an example of generating an authentication question that may be presented to a user. The elements in FIGS. 6A-B are representations of various steps in the method 400 depicted in FIG. 4, such as those depicted with respect to steps 407 through 410 of the method 400. As illustrated in FIG. 6A, the computing device (e.g., authentication server 302) may determine initial merchant choices for a user based on the user's transaction history. The false merchant choices might be a merchant with which the user has not conducted a transaction with in, for example, the past 30 days using the user's account. The computing device may determine the initial false merchant choices 601 for a user in a predetermined time period, e.g. the past 30 days. For example, the initial false merchant choices 601 may include Pizzeria, Oceanview Seafood, MexTex, Pat's Store and ABC Market. The computing device may determine, using a trained first or second machine learning model, the merchant names related to P2P transactions. The computing device may determine the merchant names related to the P2P transactions without using a machine learning model. The computing device may generate modified merchant choices 602 by excluding or removing Pizzeria and Oceanview Seafood from the set of false merchant choices. To minimize confusion and reduce authentication failure for a legitimate user, the computing device may take an approach to be overly exclusive and also remove Pat's Store from the false merchant choices given its names starts with letter “P.” After the computing device exclude or remove P2P transactions, the modified false merchant choices 602 include a subset of the initial choices: MexTex and ABC Market.

The authentication question 620 may be generated and presented on user device 600 in FIG. 6B based on the described herein for reducing confusion and increasing memorability with respect to presented merchant choices. For purposes of illustration, the authentication question 620 is illustrated as an authentication question based on modified false merchant choices 602 in FIG. 6A. The authentication question 620 may include a prompt 606. The prompt may include a merchant identifier 604. The authentication question 620 may further include a set of possible answers 608 (e.g., a manner for the user to answer True (“T”) or False (“F”) in response to the prompt 606). The authentication question 620 may be generated based on the modified false merchant choices 602. By generating the authentication question 620 based on the modified false merchant choices 602, the computing device may avoid presenting an authentication question that may confuse the user by excluding data (e.g., a merchant name) related to P2P transactions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device comprising:
one or more processors; and
memory storing instructions that, when executed by the one or more processors, cause the computing device to:
receive, from a user device, a request for access to a first account associated with a first user;
receive, from one or more databases, first transaction data corresponding to the first account, wherein the first transaction data indicates one or more transactions conducted by the first user;
receive second transaction data corresponding to one or more peer to peer (P2P) transactions associated with the first account;
train, based on a history of P2P transaction records associated with a plurality of different users, a first machine learning model to identify entity names in P2P transaction record data;
provide, as input to the trained first machine learning model, the second transaction data;
receive, as output from the trained first machine learning model, one or more merchant names associated with the one or more P2P transactions conducted by the first account;
determine, based on the first transaction data, one or more false merchant choices associated with the first account;
generate a set of modified false merchant choices by excluding the one or more merchant names from the one or more false merchant choices;
generate an authentication question comprising at least one merchant choice from the set of modified false merchant choices;
generate, based on the first transaction data and the set of modified false merchant choices, a correct answer to the authentication question;
provide the authentication question to the user device;
receive, from the user device, a response to the authentication question; and
grant the user device access to the first account based on comparing the response to the authentication question to the correct answer.

2. The computing device of claim 1, wherein the second transaction data comprises memo line information associated with each of the one or more P2P transactions.

3. The computing device of claim 1, wherein the instructions, when executed by the one or more processors, cause the computing device to:
train, based on the history of P2P transaction records, a second machine learning model to determine predicted intent for shared expense associated with the P2P transactions conducted by the plurality of different users;
provide, as input to the trained second machine learning model, the second transaction data; and
receive, as output from the trained second machine learning model, intent data indicating whether the one or more P2P transactions conducted by the first account are intended for shared expense, wherein the instructions, when executed by the one or more processors, cause the computing device to: generate the set of modified false merchant choices based on the intent data.

4. The computing device of claim 3, wherein the history of P2P transaction records associated with the plurality of different users comprises transaction amounts and transaction frequencies, wherein the instructions, when executed by the one or more processors, cause the computing device to:
train the second machine learning model to output, based on the transaction amounts and the transaction frequencies, the predicted intent for shared expense associated with the P2P transactions conducted by the plurality of different users.

5. The computing device of claim 1, wherein the history of P2P transaction records comprises merchant category information, wherein the instructions, when executed by the one or more processors, cause the computing device to:
determine, based on the merchant category information and using the trained first machine learning model, one or more merchant categories associated with the one or more P2P transactions conducted by the first account, wherein the instructions, when executed by the one or more processors, cause the computing device to: generate the set of modified false merchant choices by excluding merchants matching the determined one or more merchant categories.

6. The computing device of claim 1, wherein the history of P2P transaction records comprises one or more entity names having first letter capitalized as indicated on memo lines, wherein the instructions, when executed by the one or more processors, cause the computing device to:
determine, based on the one or more entity names and using the trained first machine learning model, at least one letter in an entity name having its first letter capitalized, and the entity name is associated with the one or more P2P transactions conducted by the first account, wherein the instructions, when executed by the one or more processors, cause the computing device to: generate the set of modified false merchant choices by excluding the one or more merchant names starting with the determined letter.

7. The computing device of claim 1, wherein the instructions, when executed by the one or more processors, cause the computing device to:
extract, from the second transaction data, memo line information by using natural language processing (NLP) to parse the memo line information to extract key words, wherein the instructions, when executed by the one or more processors, cause the computing device to:
train the first machine learning model to identify the entity names based on the key words.

8. The computing device of claim 1, wherein the one or more P2P transactions comprise outbound transactions associated with one or more payments sent by the first account via the one or more P2P transactions.

9. The computing device of claim 1, wherein the one or more P2P transactions comprise external transactions associated with one or more payments sent by the first account in a first financial institution to an external account in a second financial institution.

10. A method comprising:
receiving, from a user device, a request for access to a first account associated with a first user;
receiving, from one or more databases, first transaction data corresponding to the first account, wherein the first transaction data indicates one or more transactions conducted by the first user;
receiving second transaction data corresponding to one or more peer to peer (P2P) transactions associated with the first account;
training, based on a history of P2P transaction records associated with a plurality of different users, a first machine learning model to identify entity names in P2P transaction record data;
providing, as input to the trained first machine learning model, the second transaction data;
receiving, as output from the trained first machine learning model, one or more merchant names associated with the one or more P2P transactions conducted by the first account;
determining, based on the first transaction data, one or more false merchant choices associated with the first account;
generating a set of modified false merchant choices by excluding the one or more merchant names from the one or more false merchant choices;
generating an authentication question comprising at least one merchant choice from the set of modified false merchant choices;
generating, based on the first transaction data and the set of modified false merchant choices, a correct answer to the authentication question;
providing the authentication question to the user device;
receiving, from the user device, a response to the authentication question; and
granting the user device access to the first account based on comparing the response to the authentication question to the correct answer.

11. The method of claim 10, wherein the second transaction data comprises memo line information associated with each of the one or more P2P transactions.

12. The method of claim 10, further comprising:
training, based on the history of P2P transaction records, a second machine learning model to determine predicted intent for shared expense associated with the P2P transactions conducted by the plurality of different users;
providing, as input to the trained second machine learning model, the second transaction data; and
receiving, as output from the trained second machine learning model, intent data indicating whether the one or more P2P transactions conducted by the first account are intended for shared expense,
wherein generating the set of modified false merchant choices is based on the intent data.

13. The method of claim 12, wherein the history of P2P transaction records associated with the plurality of different users comprises transaction amounts and transaction frequencies, wherein training the second machine learning model comprises:
training the second machine learning model to output, based on the transaction amounts and the transaction frequencies, the predicted intent for shared expense associated with the P2P transactions conducted by the plurality of different users.

14. The method of claim 12, wherein the history of P2P transaction records associated with the plurality of different users comprises merchant category information, the method further comprising:
determining, based on the merchant category information and using the trained first machine learning model, one or more merchant categories associated with the one or more P2P transactions conducted by the first account; and
wherein generating the set of modified false merchant choices comprises excluding merchants matching the determined one or more merchant categories.

15. The method of claim 10, further comprising:
extracting, from the second transaction data, memo line information by using natural language processing (NLP) to parse the memo line information to extract key words; and
training the first machine learning model to determine the entity names based on the key words.

16. One or more non-transitory computer-readable media storing instructions that, when executed by one or more processors, cause a computing device to:
receive, from a user device, a request for access to a first account associated with a first user;
receive, from one or more databases, first transaction data corresponding to the first account, wherein the first transaction data indicates one or more transactions conducted by the first user;
receive second transaction data corresponding to one or more peer to peer (P2P) transactions associated with the first account;
train, based on a history of P2P transaction records associated with a plurality of different users, a first machine learning model to identify entity names in P2P transaction record data;
provide, as input to the trained first machine learning model, the second transaction data;
receive, as output from the trained first machine learning model, one or more merchant names associated with the one or more P2P transactions conducted by the first account;
determine, based on the first transaction data, one or more false merchant choices associated with the first account;
generate a set of modified false merchant choices by excluding the one or more merchant names from the one or more false merchant choices;
generate an authentication question comprising at least one merchant choice from the set of modified false merchant choices;
generate, based on the first transaction data and the set of modified false merchant choices, a correct answer to the authentication question;
provide the authentication question to the user device;
receive, from the user device, a response to the authentication question; and
grant the user device access to the first account based on comparing the response to the authentication question to the correct answer.

17. The computer-readable media of claim 16, wherein the second transaction data comprises memo line information associated with each of the one or more P2P transactions.

18. The computer-readable media of claim 16, wherein the instructions, when executed by the one or more processors, cause the computing device to:
train, based on the history of P2P transaction records, a second machine learning model to determine predicted intent for shared expense associated with the P2P transactions conducted by the plurality of different users;
provide, as input to the trained second machine learning model, the second transaction data; and
receive, as output from the trained second machine learning model, intent data indicating whether the one or more P2P transactions conducted by the first account are intended for shared expense, wherein the instructions, when executed by the one or more processors, cause the computing device to generate the set of modified false merchant choices based on the intent data.

19. The computer-readable media of claim 16, wherein the one or more P2P transactions comprise outbound transactions associated with one or more payments sent by the first account via the one or more P2P transactions.

20. The computer-readable media of claim 16, wherein the one or more P2P transactions comprise external transactions associated with one or more payments sent by the first account in a first financial institution to an external account in a second financial institution.
